(19) United States
(12) Patent Application Publication
(10) Pub. No.: US 2025/0243012 A1
(43) Pub. Date: Jul. 31, 2025

(54) END EFFECTOR FOR PICKING OF ITEMS

(71) Applicant: Advanced Farm Technologies, Inc., Davis, CA (US)

(72) Inventors: Evan Long, Davis, CA (US); Cedric Jeanty, Davis, CA (US)

(21) Appl. No.: 18/833,631

(22) PCT Filed: Feb. 7, 2023
(86) PCT No.: PCT/US2023/012493

§ 371 Date: Jul. 26, 2024

Related U.S. Application Data
(60) Provisional application No. 63/267,778, filed on Feb. 9, 2022.

(51) Int. Cl. B65G 47/91; B25J 15/06

(52) U.S. Cl. CPC B65G 47/91; B25J 15/0683; B65G 2201/0211

(57) ABSTRACT

An end effector for a picking robot, and a method of use, the end effector comprising: a body; a shaft slidably coupled to the body and extending along a longitudinal axis between a proximal end and a distal end, the shaft having a vacuum lumen extending therethrough along the longitudinal axis; a suction cup coupled to the distal end of the shaft such that an interior volume of the suction cup is in fluid communication with the vacuum lumen; a vacuum generator connected to the vacuum lumen at the proximal end of the shaft and configured to create suction therethrough; and a linear actuator configured to slide the shaft along the longitudinal axis between an extended position in which the suction cup is relatively farther from the body and a retracted position in which the suction cup is relatively closer to the body.

### CROSS-REFERENCE TO RELATED APPLICATIONS

This application claims the benefit of U.S. Provisional Application Ser. No. 63/267,778, filed Feb. 9, 2022, entitled END EFFECTOR FOR PICKING OF ITEMS, which is incorporated by reference herein in its entirety.

### FIELD

The present disclosure relates to devices and methods for picking of items such as crops.

### BACKGROUND

Industrial robots are frequently utilized in “pick and place” implementations for repeatedly retrieving and moving items. Existing systems typically require items to be pre-sorted in predetermined locations such as bins or conveyors, and are not able to accurately and precisely identify and retrieve items in cluttered environments. Many existing industrial robots are also not designed to pick and place delicate objects that can be easily damaged during the acts of picking up the object, moving the object to a new location, and/or releasing the object into the new location. Robots that are designed to manipulate easily-damaged objects typically include very precise mechanical specifications and small tolerances for error to achieve high accuracy and near 100% success rate in picking and placing the object without damaging it. Such robots tend to be heavy, costly machines that are ill-suited for pick and place operations in industrial and agricultural environments and are unable to move through a field of objects with agility and precision to avoid damaging objects of interest during picking operations. In addition, existing industrial robots are not designed to pick up a plurality of delicate, differently shaped and sized objects that are stationary and tethered such as to trees or to the ground as the objects enter into a work space of the robot moving by the plurality of objects. Accordingly, there is a need for improvement in many aspects of autonomous selection and retrieval of items using robots.

### SUMMARY

The systems and methods of this disclosure each have several innovative aspects, no single one of which is solely responsible for its desirable attributes. Without limiting the scope as expressed by the claims that follow, its more prominent features will now be discussed briefly.

In a first aspect, an end effector for a picking robot comprises a body; a shaft slidably coupled to the body and extending along a longitudinal axis between a proximal end and a distal end, the shaft having a vacuum lumen extending therethrough along the longitudinal axis; a suction cup coupled to the distal end of the shaft such that an interior volume of the suction cup is in fluid communication with the vacuum lumen; a vacuum generator connected to the vacuum lumen at the proximal end of the shaft and configured to create suction therethrough; and a linear actuator configured to slide the shaft along the longitudinal axis between an extended position in which the suction cup is relatively farther from the body and a retracted position in which the suction cup is relatively closer to the body.

In some embodiments, the shaft is rotatable relative to the body about the longitudinal axis and wherein the suction cup is rotationally fixed relative to the shaft, the end effector further comprising a motor configured to cause rotation of the suction cup by rotating the shaft about the longitudinal axis.

In some embodiments, the linear actuator comprises one or more pneumatic cylinders each having a piston rod fixed relative to the distal end of the shaft. In some embodiments, the one or more pneumatic cylinders comprise two pneumatic cylinders having piston rods fixed to opposing ends of a yoke, the yoke coupled to the distal end of the shaft.

In some embodiments, the vacuum generator is coupled to the body and comprises at least one exhaust port aligned to direct exhaust gas from the vacuum generator toward the suction cup.

In some embodiments, the suction cup comprises a mating portion sized and shaped to couple the suction cup to the distal end of the shaft; a proximal bellows connected to the mating portion; and a distal bellows connected to the proximal bellows. In some embodiments, the proximal bellows and the distal bellows are configured to at least partially collapse when a pressure within the interior volume of the suction cup is lower than an ambient pressure outside the suction cup. In some embodiments, the suction cup further comprises a first plurality of radially oriented ribs spaced around a distal exterior surface of the proximal bellows and a second plurality of radially oriented ribs spaced around a proximal exterior surface of the distal bellows, the second plurality of radially oriented ribs being located to interlock alternatingly with the first plurality of radially oriented ribs when the proximal bellows and the distal bellows at least partially collapse. In some embodiments, the suction cup further comprises a lip connected to a distal end of the distal bellows and configured to deform to achieve a suction grip against a surface of an item being picked. In some embodiments, the lip comprises a section of the suction cup having a wall thickness smaller than a wall thickness of the proximal bellows and the distal bellows. In some embodiments, the lip further comprises a ridge extending circumferentially around the suction cup at a distal end of the lip, the ridge having a wall thickness greater than a wall thickness of the lip. In some embodiments, the lip comprises an interior surface disposed at an angle between 20° and 40° relative to the longitudinal axis. In some embodiments, the angle is approximately 30°.

In some embodiments, the suction cup comprises a silicone rubber having a Shore durometer of 30.

In some embodiments, the end effector is configured to pick an apple from a tree.

In a second aspect, a method of picking a fruit from a tree comprises, by a robotic process, activating a vacuum generator of an end effector to create suction through a suction cup of the end effector; engaging the fruit with the suction cup; and retracting a shaft of the end effector to which the suction cup is mounted, from an extended position to a retracted position, to pull the fruit away from the tree along a longitudinal axis of the shaft. The end effector comprises a bod; a shaft slidably coupled to the body and extending along a longitudinal axis between a proximal end connected to the vacuum generator and a distal end coupled to the suction cup, the shaft having a vacuum lumen extending therethrough such that the vacuum generator is in fluid communication with an interior volume of the suction cup; and a linear actuator configured to slide the shaft along the longitudinal axis relative to the body.

In some embodiments, retracting the shaft causes a stem of the fruit to break or to separate from the tree.

In some embodiments, the method further comprises, subsequent to engaging the fruit with the suction cup, activating a motor of the end effector to rotate the shaft, the suction cup, and the fruit about the longitudinal axis of the shaft. In some embodiments, the motor causes the fruit to rotate at a sufficient speed to cause a stem of the fruit to break or to separate from the tree. In some embodiments, the motor causes the fruit to rotate through a sufficient range of motion to fatigue the stem, and retracting the shaft causes a stem of the fruit to break or to separate from the tree. In some embodiments, engaging the fruit with the suction cup comprises moving the end effector at least partially along a direction parallel to the longitudinal axis to approach the fruit. In some embodiments, the method further comprises activating the motor to cause rotation of the suction cup while approaching the fruit. In some embodiments, the method further comprises directing exhaust gas from the vacuum generator toward the fruit while approaching the fruit to clear debris from a vicinity of the fruit.

In some embodiments, the suction cup comprises a proximal bellows, a distal bellows, and a lip that engages the fruit, the proximal bellows and the distal bellows being disposed between the lip and the shaft. In some embodiments, engaging the fruit with the suction cup causes the proximal bellows and the distal bellows to at least partially collapse such that a plurality of first ribs on the proximal bellows interlock with a plurality of second ribs on the distal bellows to facilitate transfer of torque from the shaft to the fruit.

In some embodiments, the fruit is an apple.

### BRIEF DESCRIPTION OF THE DRAWINGS

The above-mentioned aspects, as well as other features, aspects, and advantages of embodiments of the present disclosure will now be described in connection with various implementations, with reference to the accompanying drawings. The illustrated implementations are merely examples and are not intended to be limiting. Throughout the drawings, similar symbols typically identify similar components, unless context dictates otherwise.

FIG. 1 is a cross-sectional view schematically illustrating components of an example harvester in accordance with the present disclosure.

FIGS. 2A-2H depict an example end effector configured for picking items in accordance with the present disclosure.

FIGS. 3A-3F depict an example end effector suction cup in accordance with the present disclosure.

FIGS. 4A-4D depict an example sequence of picking an apple using the end effector of FIGS. 2A-2H.

### DETAILED DESCRIPTION

Embodiments of the present disclosure provide systems and methods capable of grasping and/or picking objects of interest within a cluttered environment. Throughout the following description, various embodiments will be described with reference to the example implementation of picking or harvesting agricultural crops such as apples. However, it will be understood that any of the systems, devices, or methods described herein may equally be applied to any other robotic, industrial, agricultural, or other application, for example, harvesting of other crops, handling of eggs or other delicate items, pick and place implementations, or the like.

Existing grippers are typically capable of picking items from a controlled environment, such as a conveyor, bin, flat surface, tray, or the like. However, existing gripping robots typically require the items to be well separated, sorted by type, or otherwise prepared in advance for picking. Thus, existing gripping robots generally struggle to identify, select, and/or pick items from a jumbled, crowded, or irregular environment, such as an environment in which items are close together, do not all have the same size and shape, are mixed with other debris or materials that are not intended to be picked, etc. Such environments are challenging for successful pick and place operations because locating and retrieving items of interest requires real-time analysis of many unpredictable, constantly-changing variables, such as but not limited to visibility of items of interest that are present in many different orientations and heights, and distinguishing characteristics of an item of interest from the surrounding environment (so that resources are not expended picking objects that are not of items of interest). In the case of grippers intended for use in agricultural or industrial applications, environmental conditions, such as but not limited to changing terrain, moisture levels, time of day, temperature, lighting conditions, wind conditions, and density and inertia of debris surrounding items of interest, are also unpredictable variables.

Embodiments of the present disclosure provide systems and methods capable of selecting and grasping objects of interest within a cluttered, non-static environment. Gripping devices described herein can use suction grasping in combination with one or more pick modalities including rotation and/or linear pulling to efficiently pick items. In addition, embodiments of the present disclosure can use vacuum generator exhaust streams and/or rotation or other maneuvering during approach to an item to clear obstructions from the immediate vicinity of the item. Thus, embodiments of the present disclosure may advantageously allow for efficient item picking from crowded environments, such as a jumbled, unpredictable mess of leaves, branches, and/or stems, which may be moving due to wind or other factors, to engage a particular item, such as an apple or other piece of fruit to be picked from within the mess of leaves, branches, and/or stems.

Some agricultural implementations may require a relatively high acceleration (e.g., in the range of 3 g-5 g or more), such as to separate an apple or other fruit from a stem. Advantageously, some embodiments of the present disclosure include improved suction cup structures configured to reliably transfer linear and/or rotational forces, from an end effector to an item without causing damage to the skin or other surface of the item.

Embodiments of the present disclosure additionally include end effector suction cups adapted for suction gripping of items such as agricultural crops (e.g., apples or other fruit). As will be described in greater detail, suction cups according to the present disclosure can include a number of features suitable for picking fruit from a tree using suction grasping and without relying on positive mechanical grasping. For example, in some embodiments the suction cups of the present disclosure include resilient materials which can prevent damage to the exterior of a fruit, while also including improved structures for transferring torque to a picked item despite the resilient material of the suction cup. These and other advantages of the present disclosure will now be explained in greater detail with reference to the drawings.

### Example Harvester According to the Present Disclosure

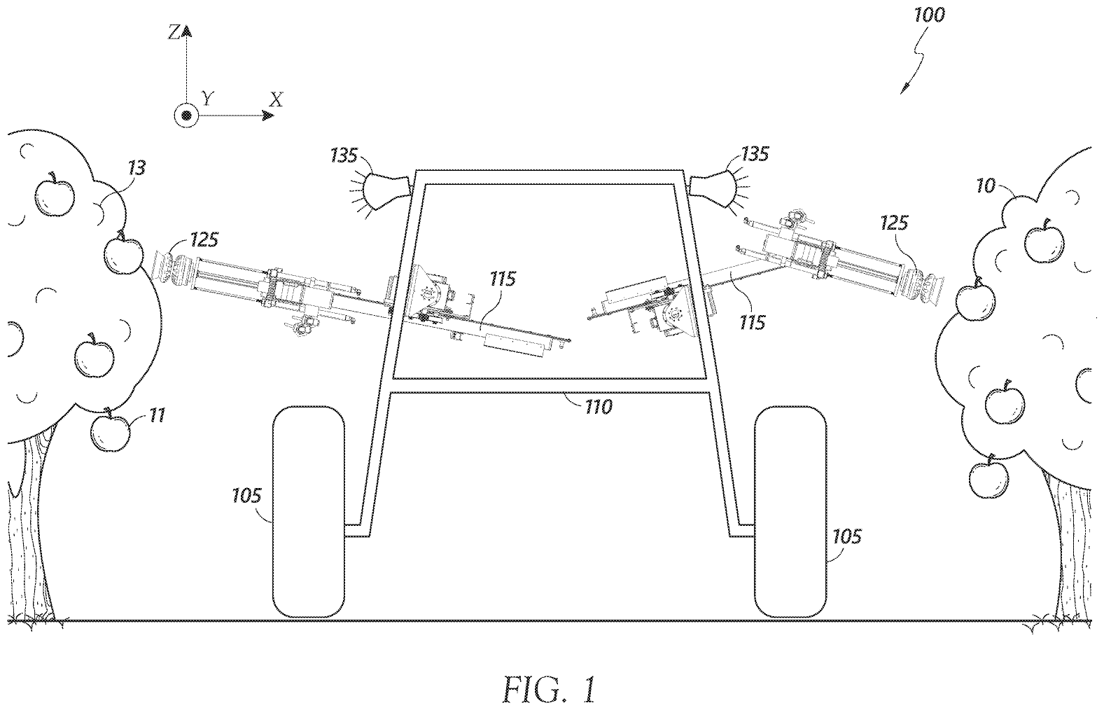

FIG. 1 is a cross-sectional view schematically illustrating components of an example harvester 100 according to the present disclosure. The harvester 100 includes a plurality of wheels 105 supporting a frame 110. The harvester 100 includes at least one robot 115 having an end effector 125 mounted thereto.

The harvester 100 is configured to travel through an orchard or other agricultural field. For example, in one particular implementation the harvester 110 can travel between rows of trees 10 having items 11 thereon, such as apples. The trees 10 may further include clutter 13 at least partially surrounding the items 11, such as leaves, branches, stems, and the like. Light sources 135 may further be provided to illuminate at least a portion of the trees 10 and the items 11 to facilitate picking and/or guidance operations.

The robots 115 may be any suitable type of robot for manipulating end effectors 125. For example, as shown in FIG. 1, the robots 115 may be modified t-bots. In some embodiments, a t-bot or modified t-bot may advantageously be smaller or more compact than other types of robots and/or may include fewer components capable of extending toward components of an adjacent robot. Thus, the modified t-bot implementations described herein may advantageously reduce the probability of a collision occurring between multiple robots of a harvester, may reduce and/or simplify the computational requirements for preventing collisions between robots, may reduce interference with other objects within the picking area (e.g., branches and the like), may provide a high aspect ratio suitable for reaching into plants or other cluttered areas, or any combination of these advantages, and may include various other operational advantages.

### Example End Effector According to the Present Disclosure

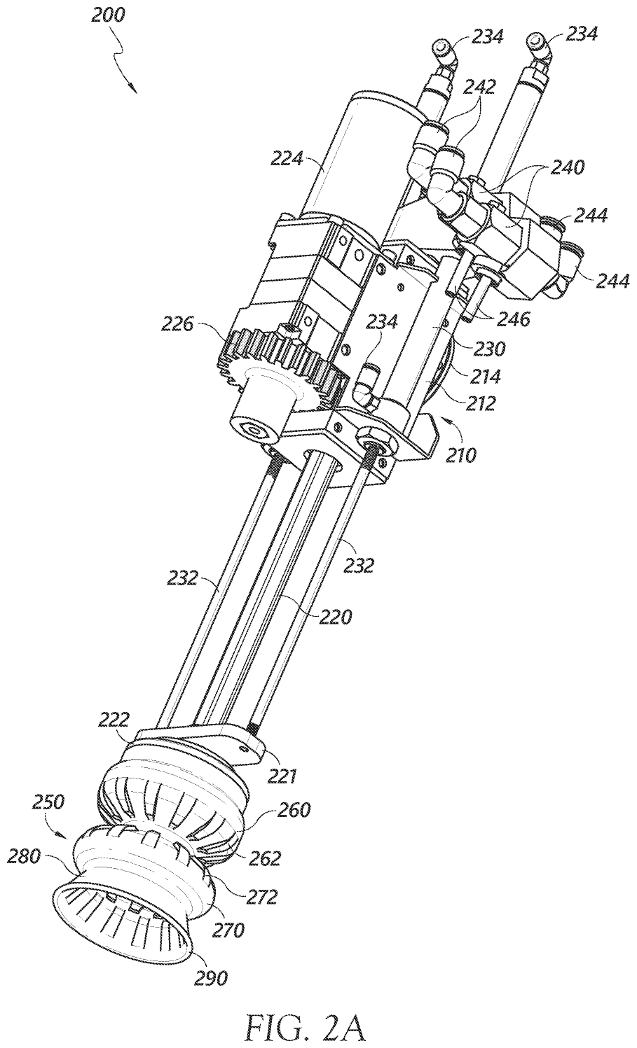

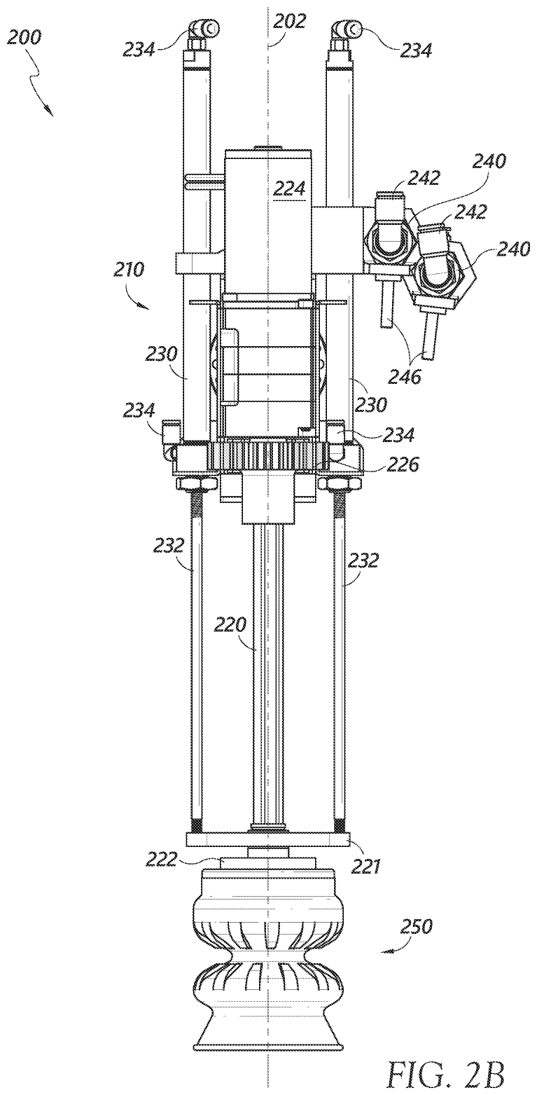

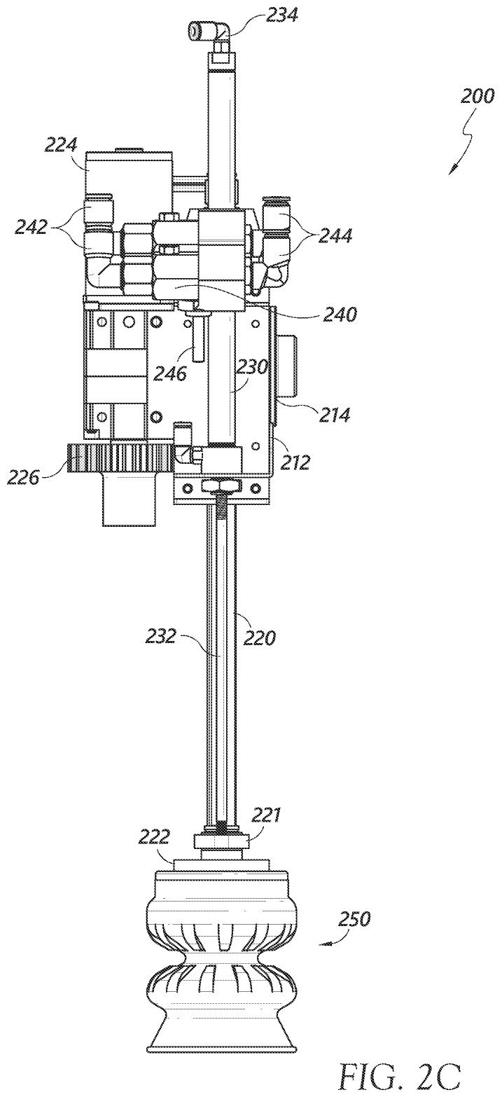

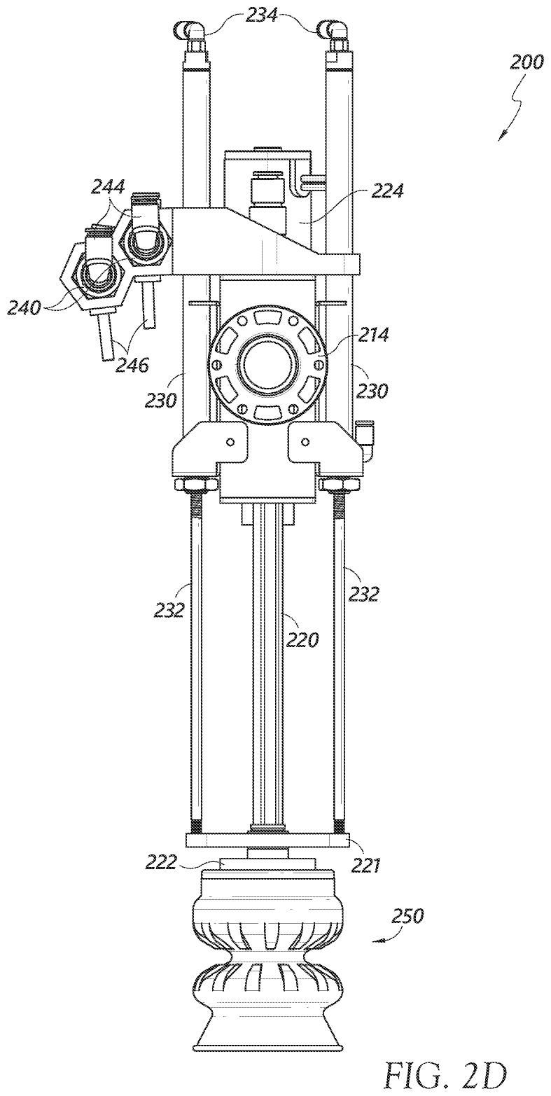

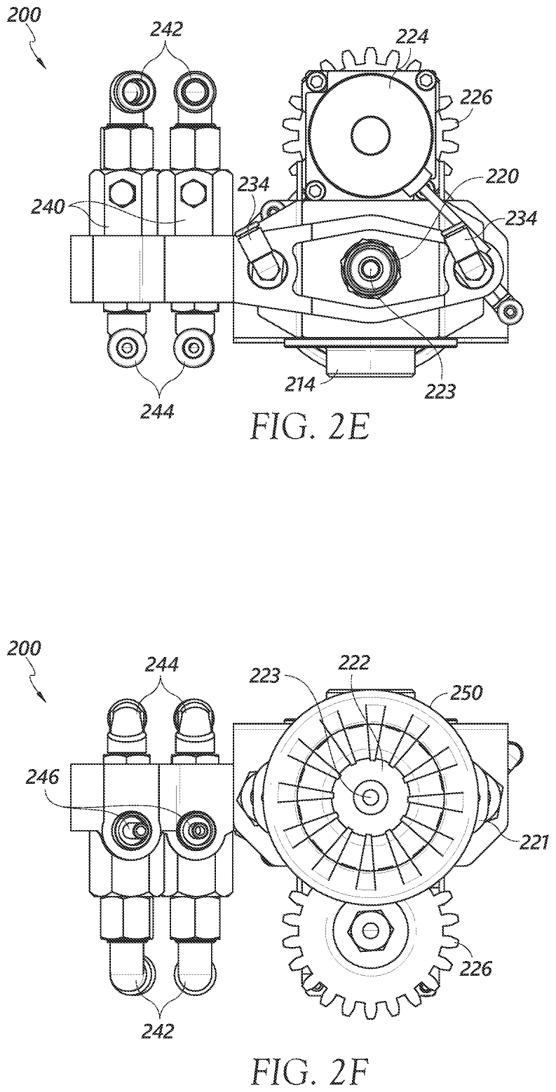

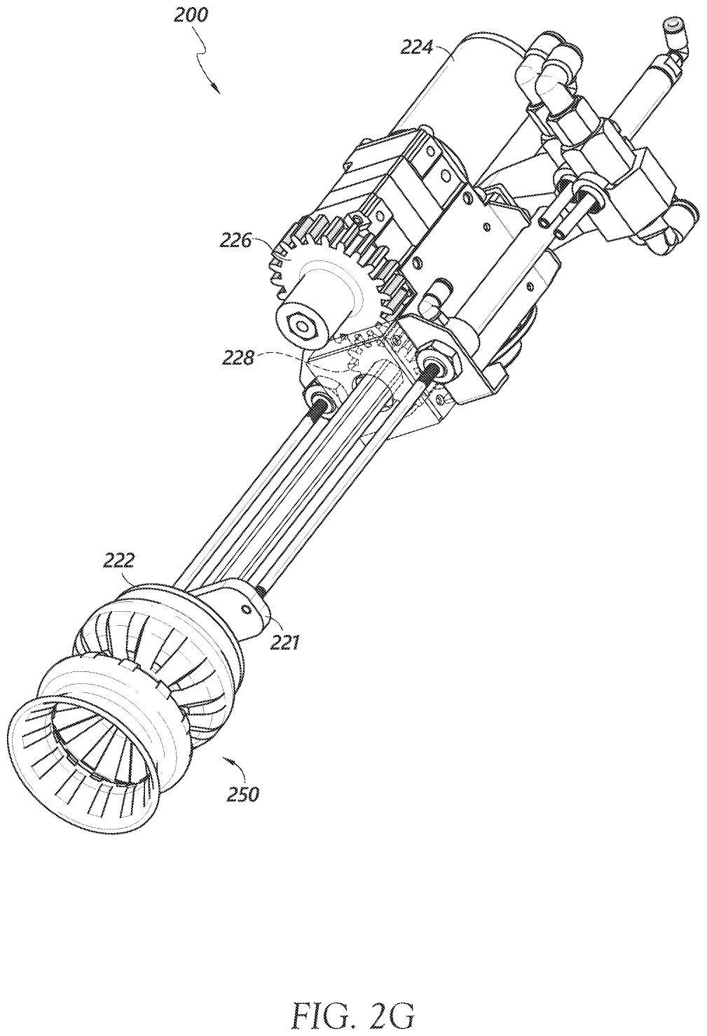

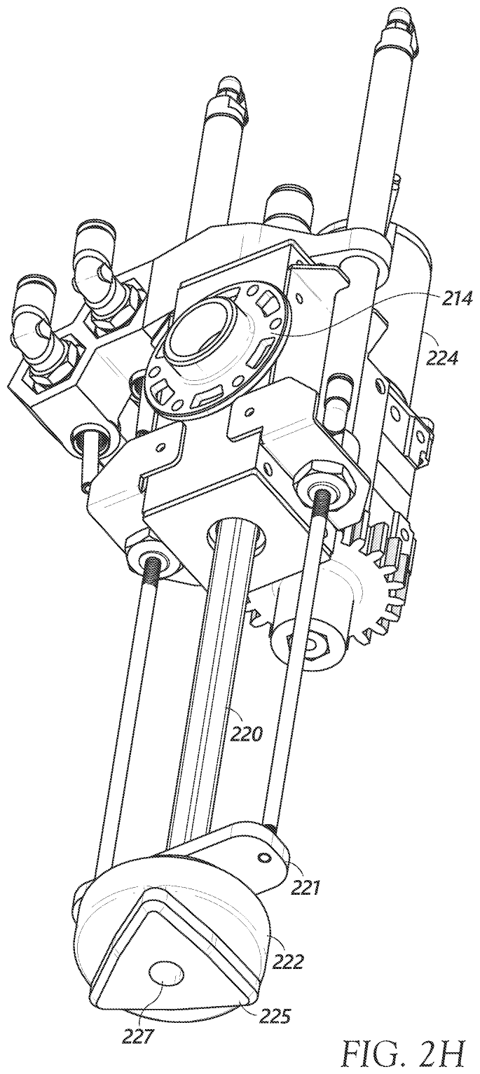

FIGS. 2A-2H depict an example end effector 200 according to one implementation of the present disclosure. The end effector 200 is configured to operate in conjunction with a robot to identify, select, and pick items. As will be described in greater detail, the end effector 200 includes various features that may provide enhanced utility for the picking of delicate items, such as apples or other agricultural products, as well as for picking items in a cluttered and/or non-static environment. The end effector 200 may operate at least partially under the control of a controller and/or other processing components. The end effector 200 in this example includes a body 210, a shaft 220, one or more linear actuators 230, one or more vacuum generators 240, and a suction cup 250.

The body 210 includes a housing 212 and a mounting plate 214 by which the end effector 200 can be coupled to a robot (e.g., robots 115 of FIG. 1). The body 210 can further serve as a mounting platform to which other components of the end effector 200 are coupled. For example, the shaft 220 is slidably coupled to the body 210 such that the shaft 220 can move along a longitudinal axis 202 of the end effector 200 relative to the body 210. The shaft 220 can further be rotatably coupled to the body 210 such that shaft 220 can rotate relative to the body 210 about the longitudinal axis 202. Linear actuators 230, a motor 224 for rotating the shaft 220, and the vacuum generators 240 can further be coupled to the body 210 of the end effector 200.

The shaft 220 extends perpendicularly downward from the body 210 along the longitudinal axis 202. A distal end of the shaft 220 can be coupled to a yoke 221. The distal end of the shaft 220 may further be coupled to a suction cup base 222. The shaft 220 may be rotatably coupled to the yoke 221 such that the shaft 220 can be moved along the longitudinal axis 202 by the yoke 221 (e.g., under control of linear actuators 230), but can also rotate freely (e.g., under control of motor 224) without causing rotation of the yoke 221. The shaft 220 can have a vacuum lumen 223 extending therethrough such that suction can be transferred from the one or more vacuum sources 240 to the suction cup through the shaft 220 via the vacuum lumen 223. A proximal end of the shaft 220 opposite the distal end can be fluidically coupled to the one or more vacuum generators 240, such as by one or more tubes.

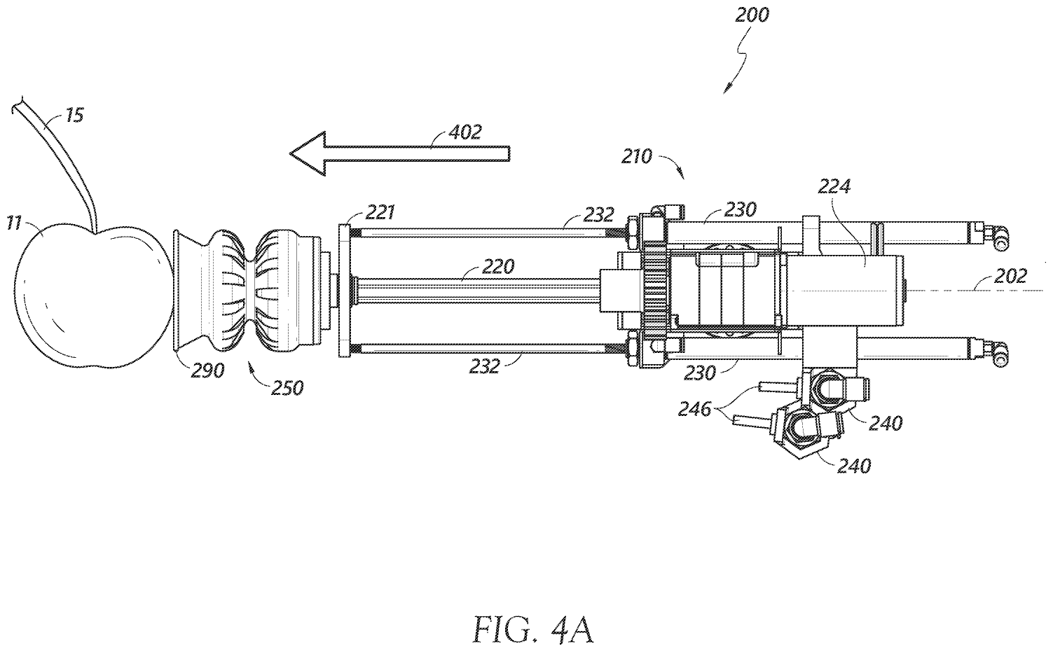

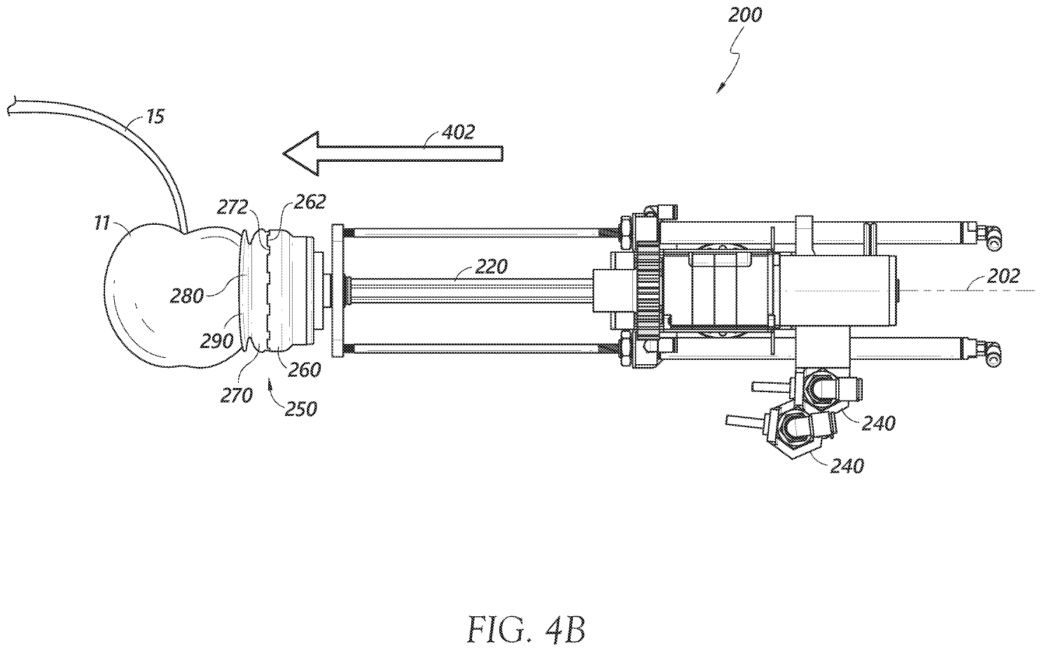

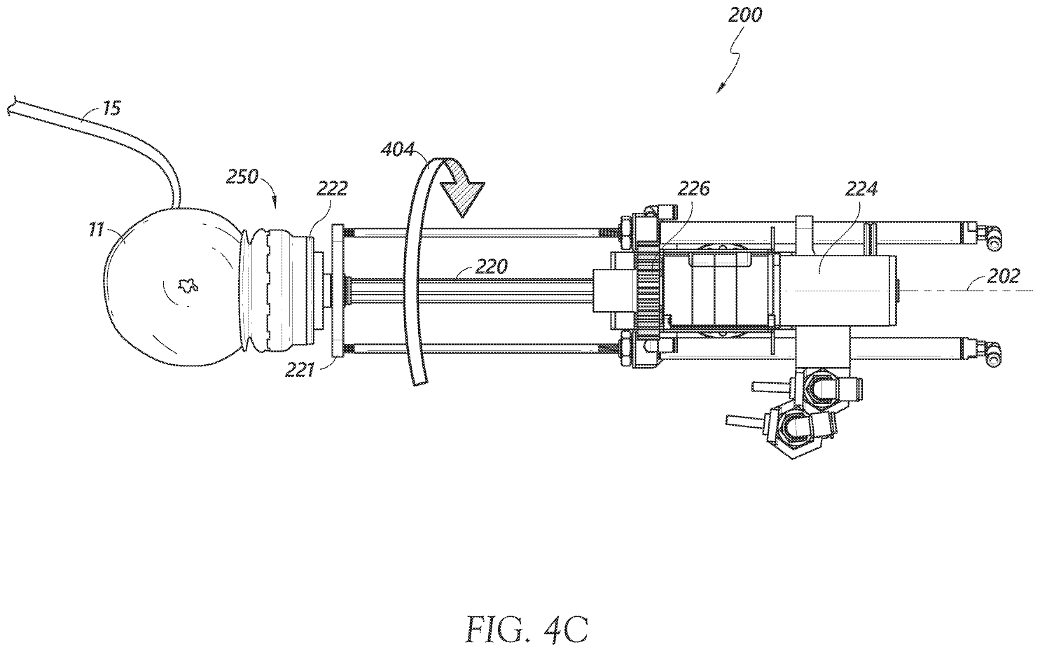

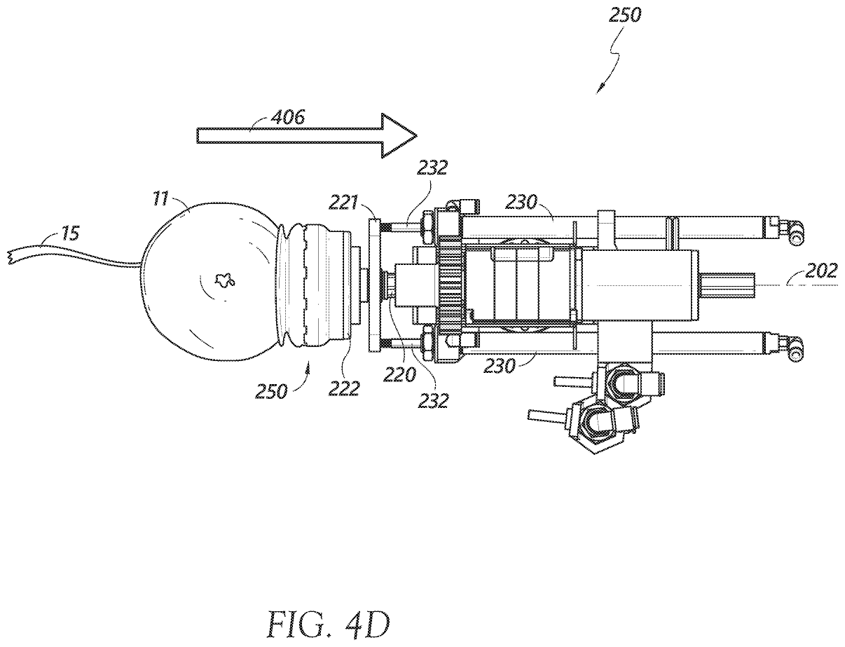

The shaft 220 is shown in FIGS. 2A-2H in an extended position in which the proximal end of the shaft 220 is positioned within the housing 212 of the body 210 and the distal end of the shaft 220 is extended away from the body 210. The shaft 220 is slidable between the extended position shown in FIGS. 2A-2H and a retracted position (e.g., as shown in FIG. 4D) in which the distal end of the shaft is relatively closer to the body 210. In some embodiments, the proximal end of the shaft 220 extends beyond the housing 212 when the shaft 220 is in the retracted position. As will be discussed in greater detail with reference to the pick sequence of FIGS. 4A-4D, movement from the extended position to the retracted position may be used to detach an item such as an apple from a tree.

A motor 224 is mounted to the body 210 of the end effector 200 and is configured to rotate the shaft 220 about the longitudinal axis 202. For example, as shown in FIG. 2G, in some embodiments an output shaft of the motor 224 can be coupled to a motor gear 226 which meshes with a shaft gear 228 rotationally coupled about the shaft 220 such that activation of the motor 224 causes rotation of the shaft 220. Other configurations for rotation of the shaft 220 can be suitably implemented. In various embodiments, the motor 224 can be configured to rotate the shaft 220 in a single direction (e.g., clockwise or counterclockwise), or can be configured for bi-directional operation and can selectively rotate the shaft either clockwise or counterclockwise about the longitudinal axis 202.

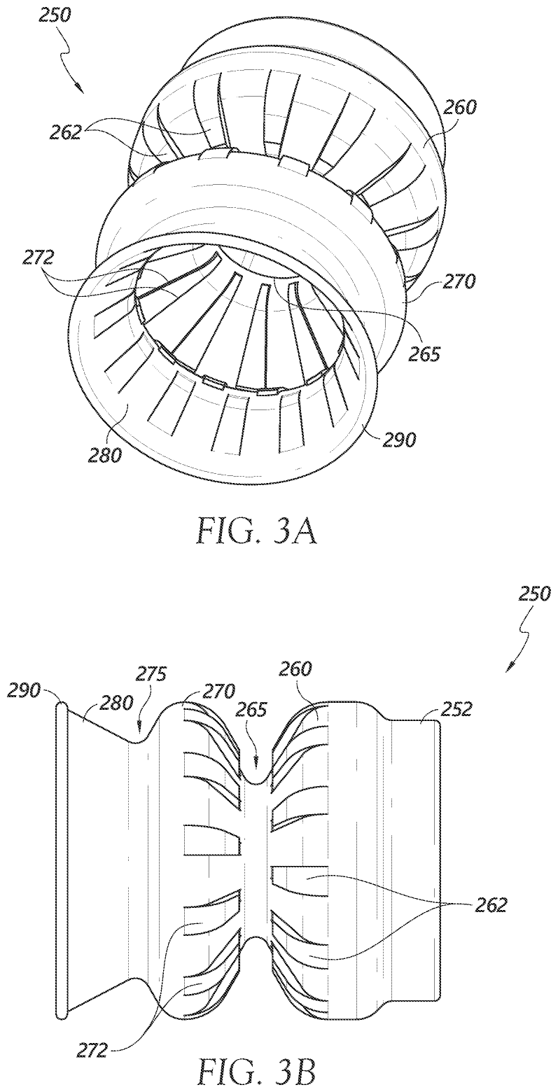

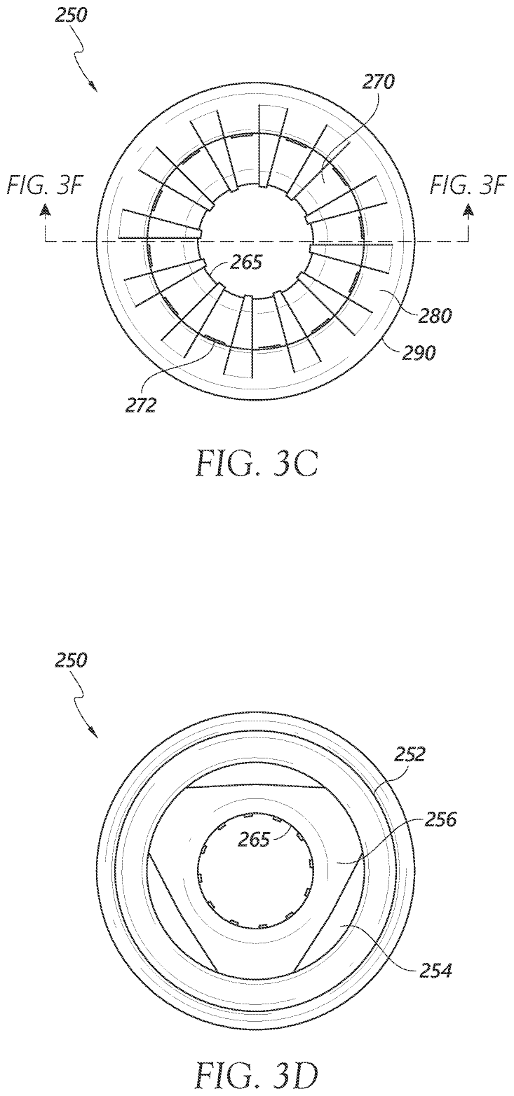

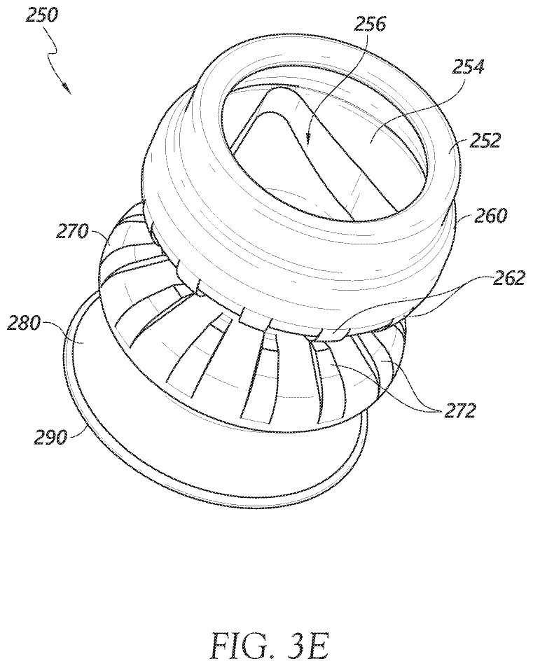

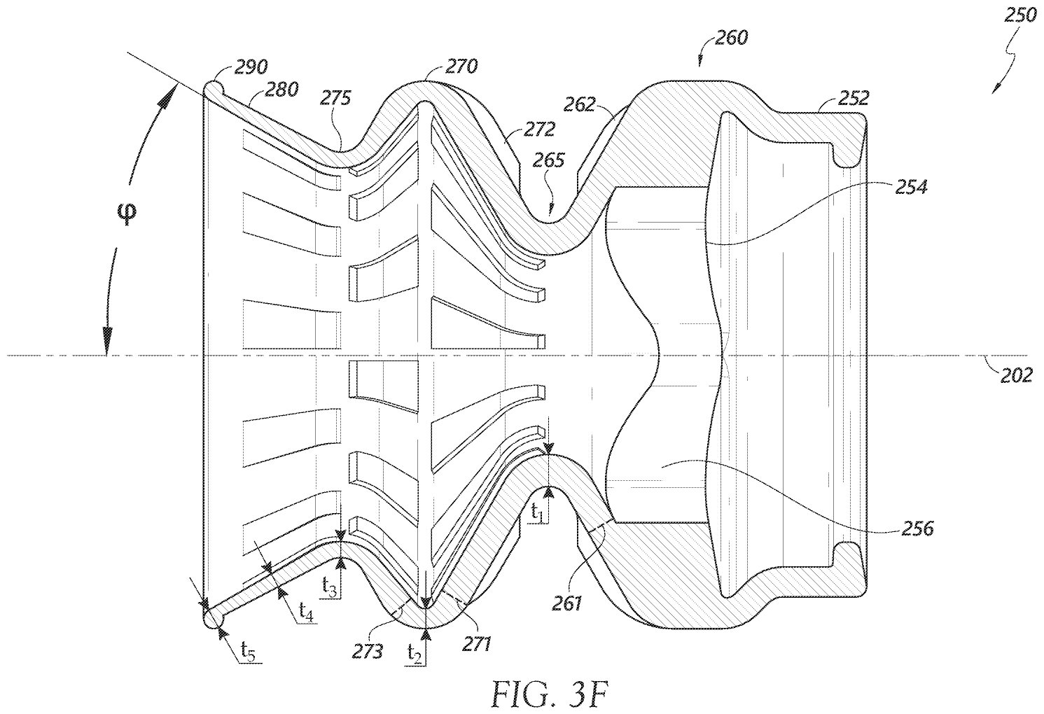

The suction cup base 222 is fixed to the distal end of the shaft 220 and can serve as a mounting platform for the suction cup 250. As will be described in greater detail, the suction cup 250 can include a resilient material such as a rubber or other polymeric material. The suction cup 250 may be removable, interchangeable, and/or replaceable (e.g., in case of a tear or other damage to the suction cup 250). Moreover, the suction cup base 222 may be the primary structure transferring linear and rotational movement from the shaft 220 to the suction cup 250. As shown in FIG. 2H, in which the suction cup 250 is hidden for purposes of illustration, the suction cup base 222 can include an interlocking structure 225 sized and shaped to engage with a complementary structure of a mating portion of the suction cup 250, as will be described in greater detail with reference to FIGS. 3A-3F. Other configurations for coupling the suction cup base 222 and the suction cup 250 can be suitably implemented. An aperture 227 in the suction cup base 222 provides fluid communication between an interior volume of the suction cup 250 and the vacuum lumen 223 of the shaft 220.

Linear actuators 230 can be any suitable type of actuator for translating the shaft 220 along the longitudinal axis 202. In the example embodiment illustrated in FIGS. 2A-2H, the linear actuators 230 are pneumatic cylinders having pistons therein connected to piston rods 232. Piston rods 232 each have a proximal end coupled to the piston within the corresponding pneumatic cylinder and a distal end coupled to the yoke 221. The pneumatic cylinders can be actuated via pneumatic connectors 234.

Vacuum generators 240 can further be coupled to the body 210 of the end effector 200. Vacuum generators 240 may be any suitable type of device for creating negative pressure in a line coupled to the vacuum lumen 223 of the shaft 220. Although the end effector 200 illustrated in FIGS. 2A-2H has two vacuum generators 240, in various embodiments the end effector 200 may have any number of vacuum generators 240, such as a single vacuum generator or three or more vacuum generators, selected based on the strength of the individual vacuum generators and/or a desired amount of suction to be applied through the shaft 220 to the suction cup 250.

The vacuum generators 240 may be venturi vacuum generators or other devices having an inlet port 242 connected to a compressed gas (e.g., air) source and a vacuum port 244 connected to the vacuum lumen 223 at the proximal end of the shaft 220. The vacuum generators 240 can further include an exhaust port 246 through which exhaust gas (e.g., the compressed gas and any air or other gas from the suction cup 250 and/or vacuum lumen 223) is expelled from the vacuum generators 240.

In addition to creating vacuum pressure for picking items with the suction cup 250, the vacuum generators 240 may also advantageously be used to clear obstructions such as leaves, stems, or other matter from the immediate vicinity of items being picked. For example, in some embodiments the vacuum generators 240 may be aligned such that the exhaust ports 246 are pointed so as to direct the exhaust gas toward the suction cup 250. In such embodiments, the exhaust ports 246 may be aligned parallel to the longitudinal axis 202 or nearly parallel to the longitudinal axis 202 (e.g., within 5 degrees, within 10 degrees, or within 15 degrees of the longitudinal axis) such that the stream of exhaust gas leaving the exhaust ports 246 pushes away relatively light clutter such as leaves and stems in the vicinity of the suction cup 250.

The suction cup 250 is coupled to the suction cup base 222 at the distal end of the shaft 220. The suction cup 250 can be rotationally coupled to the shaft 220 such that rotation of the shaft 220 causes corresponding rotation of the suction cup 250. The suction cup 250 can include a proximal bellows 260, a distal bellows 270, and a lip 280 bounded by a ridge 290. Interlocking ribs 262 and 272 can be provided on the proximal bellows 260 and the distal bellows 270, respectively, to improve the transfer of torque through the suction cup 250 while the suction cup is in a collapsed state when engaged with an item. Various features and advantages of the suction cup 250 will be described in greater detail with reference to FIGS. 3A-3F. An example picking sequence using the end effector 200 will be described in greater detail with reference to FIGS. 4A-4D.

The suction cup 250 and/or a portion of the end effector 200 (e.g., suction cup base 222 or shaft 220) may further include a vacuum sensor (e.g., a pressure sensor) configured to detect a pressure in the interior volume of the suction cup 250. In some embodiments, the vacuum generators 240 may continuously create a negative pressure at the suction cup 250. As long as the lip 280 is open to the atmosphere and is not obscured by an item, the vacuum sensor may detect a consistent pressure similar to or slightly lower than atmospheric pressure. However, when the opening of the lip 280 and/or ridge 290 is obscured or blocked (as, for example, when the suction cup 250 engages with the surface of an item), the pressure within the suction cup 250 may drop substantially lower due to the operation of the vacuum generators 240. Accordingly, a sudden low-pressure detection at the vacuum sensor may indicate to a controller or other processing circuitry that the suction cup 250 has contacted an item.

Varying degrees of pressure measured by the vacuum sensor can also be used to indicate degree and sufficiency of engagement with the contacted item. In the non-limiting example of apple picking, an optimal engagement with a relatively flat and smooth side of an apple may result in a the sensor measuring a relatively lower or lowest pressure, while engagement with the calyx or stem, or a combination of the apple and the calyx or stem, may result in a less effective seal and a corresponding higher pressure measurement. Other scenarios may also be detected when a less optimal seal causes a reduced vacuum. For example, a reduced vacuum and a less optimal seal may be detected when a relatively small apple or other matter such as leaves are sucked up into the suction cup 250, or when a stem or leaf is positioned between the lip 280 of the suction cup 250 and the body of the apple. In some embodiments, a vacuum generator 240 located relatively near the suction cup 250 may advantageously enhance detection at the vacuum sensor. For example, where the vacuum cavity is small (e.g., where the vacuum generators 240 are mounted on the end effector 200 close to the vacuum lumen 223 of the shaft 220, rather than being located elsewhere on a robot or harvester farther from the end effector 200), evacuation of the cavity occurs relatively quickly when the suction cup 250 is blocked, resulting in a shorter time required to detect engagement with an item.

### Example End Effector Suction Cup According to the Present Disclosure

FIGS. 3A-3F depict the suction cup 250 of FIGS. 2A-2H in accordance with the present disclosure. FIG. 3F is a cross-section of the suction cup 250 taken about the line 3F-3F in FIG. 3C. The suction cup 250 may include a number of advantageous features that render the suction cup 250 particularly suitable for picking items such as apples or other fruit. For example, features of certain embodiments of the suction cup 250 can be especially advantageous for sealing to irregularly and/or differently shaped items such as apples or other fruit. Some features may be especially advantageous for sealing in the presence of obstructions such as leaves and/or stems. Furthermore, some features may be especially advantageous for transferring to an item the torque and/or linear force needed to pick a piece of fruit from a tree or other structure. Although the suction cup 250 is shown and described as being used with the example end effector 200 of FIGS. 2A-2H, the suction cup 250 can equally be used in conjunction with a variety of end effectors 200 for picking items without departing from the scope of the present disclosure. Moreover, although the end effector 200 of FIGS. 2A-2H is shown and described as being used with the example suction cup 250, the present disclosure is not limited to this particular embodiment of a suction cup, and suction cups having other features, shapes, and sizes can also be suitably implemented in embodiments of the present disclosure.

The suction cup 250 includes a mating portion 252 at a proximal end of the suction cup 250, a proximal bellows 260 adjacent to the mating portion 252, a distal bellows 270 adjacent to the proximal bellows 260 at a proximal waist 265, and a lip 280 adjacent to the distal bellows 270 at a distal waist 275. The distal end of the lip 280 terminates in a ridge 290. The ridge 290 can bound or reinforce the distal end of the lip 280.

The suction cup 250 can include any suitable material such as a rubber, a polymeric material, or the like. The material forming the suction cup 250 can be a deformable and resilient material so as to form a reliable seal with an item being picked. For example, in some embodiments the suction cup 250 is made partially or entirely from a cast silicone rubber. The Shore durometer value, indicating the relative hardness or resilience of the material, can be, for example, between approximately 10 and 60. It has been determined empirically that durometer values between 20 and 40, such as 30, may provide desirable performance for picking fruit such as apples. It was determined that 30 durometer cast silicone rubber provided desirable transfer of motion and torque to an item being picked while being resilient enough to avoid damage to an apple skin and/or the underlying flesh. In some embodiments, the suction cup 250 is formed from a single integral piece of the rubber or other material.

As shown in FIGS. 3D-3F, the mating portion 252 is sized and shaped to fit around the suction cup base 222 of the end effector 200 (FIG. 2H). An interlocking structure 254 of the suction cup 250 includes a recess 256 sized and shaped to be complementary to the interlocking structure 225 of the suction cup base 222. The interlocking structure 225 of the suction cup base 222 and the complementary recess 256 of the suction cup 250 can have a non-circular shape, such as the rounded or modified triangular shape illustrated in FIGS. 2H and 3D-3E, or another suitable shape such as a linear, rectangular, or polygonal shape through which torque can be transferred from the suction cup base 222 to the suction cup 250.

The suction cup 250 is configured to deform upon engaging an item such as an apple, to a compressed configuration (e.g., as shown in FIGS. 4B-4D). In the compressed configuration, the suction cup 250 may collapse or bend at the proximal waist 265 and/or at the distal waist 275. Such collapsing or bending can occur when the lip 280 seals around an object (such as an apple) and at least partially isolates the inner volume of the suction cup 250 from the ambient environment, due to the negative pressure applied to the interior volume of the suction cup 250 through the vacuum lumen 223 of the shaft 220.

As shown in FIGS. 3A, 3B, and 3E, the ribs 262 on the distal side of the proximal bellows 260 are positioned to be interlocking, rather than overlapping, with the ribs 272 on the proximal side of the distal bellows 270. Thus, when the proximal waist 265 collapses upon engagement with an item, each rib 262 of the proximal bellows 260 is disposed between two ribs 272 of the distal bellows 270 and each rib 272 of the distal bellows 270 is correspondingly disposed between two ribs 262 of the proximal bellows 260. In some embodiments, the widths of the individual ribs 262, 272 may be selected to be equal to or slightly smaller than the spacing between adjacent ribs 262, 272 such that any gaps between the interlocking ribs 262, 272 are reduced or eliminated when in the compressed configuration. Thus, when a torque is applied to the mating portion 252 of the suction cup 250 in the compressed configuration, the interlocking ribs 262, 272 enhance the efficiency of torque transfer from the proximal bellows 260 to the distal bellows 270. The interlocking ribs 262, 272 can additionally reduce the probability of structural failure of the suction cup 250 (e.g., at the proximal waist 265 or elsewhere) due to such torque.

As shown in the cross-section of FIG. 3F, the wall of the suction cup 250 has a substantially consistent first thickness ty from a point 261 through the proximal bellows 260 and the waist 265 to a point 271 near the widest portion of the distal bellows 270. The wall of the suction cup 250 decreases to a smaller thickness t₂ at the widest point of the distal bellows 270, and increases again to t₁ at point 273 on the distal side of the distal bellows 270. The wall has a smaller thickness t₃ at the distal waist 275, which may be greater than, equal to, or less than t₂. The lip 280 similarly has a relatively thin wall of a thickness t₄ which may be greater than, equal to, or less than t₃. The thickness t₄ of the lip 280 may be constant or tapering along the length of the lip 280 from the distal waist 275 to the ridge 290. The ridge 290 has a thickness t₅ greater than the thickness t₄ of the lip 280. These dimension may have a variety of advantages, alone or in combination, as will now be described.

It will be observed that the wall thickness of the suction cup 250 is thinner or effectively thinner at the proximal waist 265 (t₁), at the distal waist 275 (t₃), and at the widest portion of the distal bellows 270 (t₂), relative to the adjacent portions of the suction cup 250. Although the wall thickness t₁ is substantially constant through the proximal waist 265, the presence of ribs 262 and 272 on opposing sides of the proximal waist 265 provides additional rigidity to the walls of the proximal bellows 260 and the distal bellows 270. Thus, the proximal waist 265 is effectively thinner, or more pliable, relative to the surrounding portions of the suction cup 250 due to the presence of the ribs 262, 272. As a result, when the opening of the suction cup 250 is at least partially blocked at the lip 280, the walls of the suction cup 250 preferentially bend at the proximal waist 265, the distal waist 275, and the widest portion of the distal bellows 270, such that a predictable accordion-type folding or collapsing can be achieved when the suction cup 250 engages an item such as an apple. Such predictable folding or collapsing can ensure that the ribs 262 and 272 interlock as expected to efficiently transfer torque and avoid torque damage to the suction cup 250. In addition, the relatively greater thickness of the wall of the suction cup 250 toward the proximal end of the suction cup 250 allows the suction cup to better support the weight of the suction cup and of an item engaged by the suction cup at the lip 280.

The relatively thin wall thickness t₄ along the lip 280 of the suction cup 250 may further be advantageous for engaging items. A relatively thin wall thickness at the lip 280 promotes deformation of the lip, such that the interior surface of the lip can conform closely to an irregularly shaped item such as, for example, an apple or other fruit that does not have a perfectly regular or precisely known shape. The thin lip 280 can also permit the suction cup 250 to form an adequate seal with an item irrespective of alignment of the item. For example, in the event that an apple is engaged by the suction cup 250 at an alignment such that a portion of the lip 280 is close to or overlapping the stem or calyx of the apple, the relatively thin wall of the lip 280 can deform sufficiently such that the presence of the stem or calyx does not prevent the suction cup 250 from forming an adequate seal for picking the apple. Similarly, the relatively pliable lip 280 can further allow the suction cup 250 to form an adequate seal in the presence of a leaf, twig, stem, or other debris that may be disposed between the lip and the surface of the item being picked.

The ridge 290 has a greater thickness relative to the lip 280 and thus serves as a reinforcing structure. The thicker ridge 290 can prevent tearing, ripping, or other damage or degradation of the relatively thin lip 280 of the suction cup. The thickness of the ridge 290 may be selected so as to be thick enough for desirable reinforcement while being thin enough to avoid interfering with the advantageous pliability of the lip 280.

With continued reference to FIG. 3F, the inner surface of the lip 280 is disposed at an angle φ relative to the longitudinal axis 202 while in the extended configuration shown in FIGS. 3A-3F (e.g., when not engaged with an item and/or collapsed). In some embodiments, the angle φ can be selected to further improve performance of the suction cup 250. For example, in some embodiments the angle φ is any angle between 15° and 45°, between 20° and 40°, between 25° and 35°, or any value or range within or bounded by any of these ranges or values, although values outside these values or ranges can be used in some cases. In the example nonlimiting embodiment illustrated in FIGS. 3A-3F, the angle φ is an angle between 28° and 32°, such as approximately 30°. In some cases, an angle φ between 20° and 40° can provide for an advantageously large surface area of contact between the lip 280 and an engaged item. For example, in the non-limiting implementation in which the suction cup 250 is used for picking apples, the illustrated angle may provide for a relatively large surface area of contact between the lip 280 and the surface of the apple over a variety of different apple sizes. A large surface area of contact with an item may be desirable, as a large surface area can increase the friction between the suction cup 250 and the item. A large surface area of contact with an item may also be desirable because a large surface can provide increased hoop strength for transfer of a rotational and/or translational force from the suction cup 250 to the item.

### Example Picking Process According to the Present Disclosure

With reference to FIGS. 4A-4D, an example picking sequence using the example end effector 200 of FIGS. 2A-2H will now be described. The picking sequence may be performed under control of one or more computing devices and/or control circuitry of the harvesters, robots, and end effectors described herein. For example, the picking sequence may be controlled at least in part by one or more software processes executing on some or all of a vehicle master controller, slave controller, end effector hub, controller, or other processing components. Although the example picking sequence of FIGS. 4A-4D is depicted and described with reference to the particular agricultural implementation of picking an apple from an apple tree, it will be understood that this sequence or similar sequences may equally be used for other agricultural or non-agricultural picking implementations.

The picking sequence begins with the end effector 200 in the initial configuration depicted in FIG. 4A. In the initial configuration of FIG. 4A, the shaft 220 is in an extended position in which the distal end of the shaft 220 and the adjacent suction cup 250 are spaced away from the body 210 of the end effector 200. In the initial configuration, the vacuum generators 240 can be active and generating a negative pressure through the shaft 220 and the interior volume of the suction cup 250. For example, in some embodiments the pressure in the vacuum lumen within the shaft 220 may be less than 60% of standard atmospheric pressure, in a range between 60% of standard atmospheric pressure and standard atmospheric pressure, between 70% and 90% of standard atmospheric pressure, between 80% and 90% of standard atmospheric pressure, or any other pressure within the above-mentioned ranges and nominally less than standard atmospheric pressure.

A robot to which the end effector 200 is mounted has moved the end effector 200 to a position at which the ridge 290 of the suction cup 250 is close to and ready to engage an apple 11 attached to a stem 15. In various embodiments, the approach of the end effector 200 may be at least partially along the direction 402. As discussed above, the path of the end effector 200 toward the apple 11 may be at least partially cleared of leaves, stems, and/or other debris by an air stream emitted by the exhaust ports 246 of the vacuum generators 240. In some embodiments, the motor 224 may further be activated to rotate the suction cup 250 about the longitudinal axis 202 during the approach as the robot moves the end effector 200 along direction 402 toward the apple 11. This rotation of the suction cup 250 during approach, which may be referred to as a drilling motion, further assists in the removal of debris such as leaves or stems from the linear path between the suction cup 250 and the apple 11 during the approach.

Referring now to FIG. 4B, the suction cup 250 suction grasps the apple 11 as the end effector 200 is further moved along direction 402 parallel to the longitudinal axis 202. In some embodiments, the apple 11 may be pulled opposite direction 402 toward the suction cup 250 when the gap between the suction cup 250 and the apple 11 is small enough, due to the negative pressure generated by the vacuum generators 240. As the apple 11 covers substantially all of the opening of the ridge 290 of the suction cup 250, the suction force causes the suction cup 250 to collapse into a collapsed state as it suction grasps the apple 11.

As shown in FIG. 4B, the suction cup 250 can deform in at least one of several ways in transitioning to the collapsed state. The lip 280 may flatten and/or otherwise deform such that at least a portion of the lip 280 sits flat against the surface of the apple 11. The ridge 290 may similarly deform to lie partially or completely against the surface of the apple 11. Accordingly, the lip 280 and the ridge 280 provide a relatively large surface area in contact with the surface of the apple 11, resulting in a high probability of a successful grasp while also reducing the probability of damage to the surface of the apple 11. As the suction cup 250 collapses, ribs 262 of the proximal bellows 260 interlock with the ribs 272 of the distal bellows 270.

The suction grasping of the apple 11 at the suction cup 250 may be detected based on data from a vacuum sensor as described above with reference to FIGS. 2A-2H. In some embodiments, if a weak grasp is detected (e.g., based on a comparison of a pressure measurement to a threshold), the suction cup 250 can be rotated or repositioned to clear debris that may be impeding a clean seal, and grasping can be attempted again. When the apple 11 has been suction grasped as shown in FIG. 4B, a processor or other control circuitry controlling the end effector 200 can proceed to separate the apple 11 from the tree.

Referring now to FIG. 4C, after the apple 11 has been suction grasped by the suction cup 250, the processor or other control circuitry can activate the motor 224 to rotate the shaft 220 and the suction cup 250 in a clockwise rotational direction 404 (or in an opposite counterclockwise direction) about the longitudinal axis 202. Such rotation may advantageously weaken the stem 15 to facilitate separation of the apple 11 from a tree branch. Advantageously, the interlocked ribs 262 and 272 of the proximal bellows 260 and distal bellows 270 (see FIG. 4B) can facilitate effective transfer of the associated torque from the suction cup base 222 to the apple 11.

Referring now to FIG. 4D, the picking sequence can be completed as the linear actuators 230 activate to pull the shaft 220 and suction cup 250 along direction 406 to a retracted position, so as to separate the apple 11 and at least a portion of stem 15 from a branch. In order to break the stem 15 and/or cause the stem 15 to detach from the apple 11, the suction cup 250 may be pulled along direction 406 at a high speed and/or acceleration. In some embodiments, the linear actuators 230 may pull the piston rods 232 along direction 406 at an acceleration in the range of 3 g to 5 g or more (e.g., as high as 6 g, 7 g, 8, 9 g, 10 g, or more, or any value or range within or bounded by any of these ranges or values, although values outside these values or ranges can be used in some cases), which pulls the carriage 221, suction cup base 222, suction cup 250, and apple 11 at substantially the same acceleration, and may exert a suitable stem separation force. In various embodiments, the stem separation force exerted may be, for example, 2N to 5N or more, and may be selected based on the particular item being picked. For example, in implementations for picking of apples, which may have relatively robust stems, the picking force may be as high as 50N, such as in the range of 10N to 40N, or more, or any value or range within or bounded by any of these ranges or values. During this rapid acceleration, the resilient and/or cushioned material forming the lip 280 of the suction cup 250 may cushion the apple 11 to prevent it from being bruised during separation. When the picking sequence has been completed, the apple 11 may be removed from the suction cup 250, either by reducing or interrupting the suction generated by the vacuum generators 240 or by mechanically moving the apple 11 laterally to break the seal with the suction cup 250.

### Example Pick Modalities According to the Present Disclosure

As described with reference to FIGS. 4A-4D, the end effector 200 can perform a number of individual movements and/or operations, consecutively or simultaneously, within a picking process. However, it will be understood that the particular sequence of operations illustrated and described with reference to FIGS. 4A-4D is only one non-limiting example embodiment of a picking process. Embodiments of the end effector 200 and robots 115 (FIG. 1) of the present disclosure can equally be used in a number of different pick modalities for picking apples, other crops, or other non-agricultural items. Several example pick modalities will now be described by way of example.

A first pick modality is consistent with the set of operations illustrated in FIGS. 4A-4D. In the first pick modality, once an apple is suction grasped by the end effector 200 at the suction cup 250, the motor 224 activates to rotate the apple relatively slowly through a range of, for example, 90 degrees, 180 degrees, 360 degrees, 720 degrees, 1080 degrees, or more, or any value or range within or bounded by any of these ranges or values, so as to fatigue the stem, as shown in FIG. 4C. Following rotation to fatigue the stem, the apple can then be separated from the tree by rapidly pulling the apple away from the tree along the longitudinal axis 202, as shown in FIG. 4D. The first pick modality may be especially suitable for apple varieties having relatively strong or damage-resistant skins.

In a second pick modality, separation of the apple from the tree can be achieved by faster rotation. For example, the rotation illustrated in FIG. 4C may be at a relatively high rotational speed (e.g., between 20 rpm and 200 rpm, between 50 rpm and 100 rpm, between 70 rpm and 90 rpm, or more, or any value or range within or bounded by any of these ranges or values, such as approximately 80 rpm) and/or through a relatively large range such as 360 degrees, 720 degrees, 1080 degrees, or more, or any value or range within or bounded by any of these ranges or values, such that the stem can be broken by rotation alone. In some embodiments, the pulling motion illustrated in FIG. 4D may be performed slowly in this pick modality, before, during, and/or after rotating the apple to break the stem. Alternatively, the pulling motion of FIG. 4D may be omitted, and the end effector 200 can remove the apple using rotation alone. The second pick modality may be especially suitable for apple varieties having relatively strong stems and/or damage-resistant skins.

In a third pick modality, the rotation of FIG. 4C can be omitted and separation of the apple from the tree can be achieved by the pulling motion of FIG. 4D alone. In some embodiments, the third pick modality can be especially suitable for picking an apple that is close to one or more other apples, where high-speed rotation could potentially cause damage to the one or more other nearby apples.

In various implementations, the pick modality for a particular picking process may be statically or dynamically selected. In an example of static selection, a single pick modality may be used for a plurality of picking operations, such as an entire tree or group of trees, based on one or more criteria such as the type of apple being picked. For example, if a group of trees bearing a variety of apple having a relatively strong skin will be harvested, the robot and end effector may be programmed to pick using the first or second pick modality described above for each apple. In an example of dynamic selection, the pick modality for each picking process may be selected in real time or near-real time based on one or more conditions associated with the individual picking process. For example, a processor controlling the end effector may be configured to cause an apple to be picked using the first pick modality if the apple will be picked from the bottom, or to cause an apple to be picked using the third pick modality if one or more other apples are detected in close proximity to the apple.

### Advantages of Implementations of the Present Disclosure

Without limiting the scope of the foregoing description, additional advantageous features of certain embodiments of the present disclosure will now be described.

Some embodiments may be advantageously adapted for picking of delicate items such as apples or other agricultural products. If these objects are bruised, scratched, discolored, or otherwise harmed by the picking process, they become nearly worthless. In some aspects, features such as resilient suction cup materials and selectable pick modalities may reduce the amount of force exerted against items and thereby reduce the probability of damaging the items during harvesting. Such harvesting without damaging the items is especially advantageous in the example of apples or other objects that must be disengaged from a tether (for example, a stem), rather than simply being picked up.

Additionally, the present disclosure provides suction cups that achieve a desirable balance between protecting the surface of an item and efficiently transferring linear and rotational motion from the shaft to an apple or other item being picked. Although the suction cups comprise a flexible and resilient material such as a rubber, the thickness profile of the disclosed suction cups which cause a predictable collapsing when picking an item, as well as the inclusion of interlocking ribs to transfer torque between the proximal and distal bellows of the suction cup, provide for efficient transfer of torque and pulling forces that might otherwise require a less resilient material.

### Further Use Cases

It will be appreciated that the systems and methods described herein are not limited to the context of picking apples or other fruit that are grown on a tree in the same or similar orientation as apples. Rather, the harvesters, robots, end effectors, and all components thereof, as described herein, may be use for a wide variety of implementations.

Other tree crops or bush crops may further be harvested using the systems and methods of the present disclosure. For example, nectarines, peaches, plums, or other stone fruits; oranges, lemons, limes, grapefruits, or other citrus fruits; avocados, guavas, persimmons, pomegranates, mangoes, peppers, and the like, may all be harvested using the technology described herein. In some embodiments, modifications to the disclosed end effectors may include changes in the size, shape, proportions, vacuum forces, etc., as required to reliably harvest each individual type of tree crop.

### Implementing Systems and Terminology

Implementations disclosed herein provide systems, methods, and devices for autonomous selection and retrieval of items using robots. One skilled in the art will recognize that these embodiments may be implemented in hardware or a combination of hardware and software and/or firmware.

Embodiments of robots and end effectors according to the present disclosure may include one or more sensors (for example, image sensors), one or more signal processors (for example, image signal processors), and a memory including instructions or modules for carrying out the processes discussed above. The robot and/or end effector may also have data, a processor loading instructions and/or data from memory, one or more communication interfaces, one or more input devices, one or more output devices such as a display device and a power source/interface. The device may additionally include a transmitter and a receiver. The transmitter and receiver may be jointly referred to as a transceiver. The transceiver may be coupled to one or more antennas for transmitting and/or receiving wireless signals.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. A computing environment can include any type of computer system, including, but not limited to, a computer system based on a microprocessor, a mainframe computer, a digital signal processor, a portable computing device, a personal organizer, a device controller, and a computational engine within an appliance, to name a few.

The foregoing description details certain embodiments of the systems, devices, and methods disclosed herein. It will be appreciated, however, that no matter how detailed the foregoing appears in text, the systems, devices, and methods can be practiced in many ways. It should be noted that the use of particular terminology when describing certain features or aspects of the present disclosure should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

The methods disclosed herein include one or more steps or actions for achieving the described methods. The method steps and/or actions may be interchanged with one another without departing from the scope of the present disclosure. In other words, unless a specific order of steps or actions is required for proper operation of the method that is being described, the order and/or use of specific steps and/or actions may be modified without departing from the scope of the present disclosure.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). Further, the term “comprising” as used herein is synonymous with “including,” “containing,” or “characterized by,” and is inclusive or open-ended and does not exclude additional, unrecited elements or method steps. Accordingly, the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component or directly connected to the second component. As used herein, the term “plurality” denotes two or more. For example, a plurality of components indicates two or more components.

It is noted that some examples above may be described as a process, which is depicted as a flowchart, a flow diagram, a structure diagram, or a block diagram. Although a flowchart may describe the operations as a sequential process, many of the operations can be performed in parallel, or concurrently, and the process can be repeated. In addition, the order of the operations may be rearranged. A process is terminated when its operations are completed. A process may correspond to a method, a function, a procedure, a subroutine, a subprogram, etc. When a process corresponds to a software function, its termination corresponds to a return of the function to the calling function or the main function.

The above description discloses several methods and materials of the present disclosure. Embodiments of the present disclosure are susceptible to modifications in the methods and materials, as well as alterations in the fabrication methods and equipment. Such modifications will become apparent to those skilled in the art from a consideration of this disclosure or practice of the present disclosure. Consequently, it is not intended that the present disclosure be limited to the specific embodiments disclosed herein, but that it cover all modifications and alternatives coming within the true scope and spirit of the present disclosure as embodied in the attached claims.

1. An end effector for a picking robot, the end effector comprising:
a body;
a shaft slidably coupled to the body and extending along a longitudinal axis between a proximal end and a distal end, the shaft having a vacuum lumen extending therethrough along the longitudinal axis;
a suction cup coupled to the distal end of the shaft such that an interior volume of the suction cup is in fluid communication with the vacuum lumen;
a vacuum generator connected to the vacuum lumen at the proximal end of the shaft and configured to create suction therethrough; and
a linear actuator configured to slide the shaft along the longitudinal axis between an extended position in which the suction cup is relatively farther from the body and a retracted position in which the suction cup is relatively closer to the body.

2. The end effector of claim 1, wherein the shaft is rotatable relative to the body about the longitudinal axis, and wherein the suction cup is rotationally fixed relative to the shaft, the end effector further comprising a motor configured to cause rotation of the suction cup by rotating the shaft about the longitudinal axis.

3. The end effector of claim 1, wherein the linear actuator comprises one or more pneumatic cylinders each having a piston rod coupled to the distal end of the shaft.

4. The end effector of claim 3, wherein the one or more pneumatic cylinders comprise two pneumatic cylinders having piston rods fixed to opposing ends of a yoke, the yoke coupled to the distal end of the shaft.

5. The end effector of claim 1, wherein the vacuum generator is coupled to the body and comprises at least one exhaust port aligned to direct exhaust gas from the vacuum generator toward the suction cup.

6. The end effector of claim 1, wherein the suction cup comprises:
a proximal bellows connected to the mating portion; and
a distal bellows connected to the proximal bellows.

7. The end effector of claim 6, wherein the proximal bellows and the distal bellows are configured to at least partially collapse when a pressure within the interior volume of the suction cup is lower than an ambient pressure outside the suction cup.

8. The end effector of claim 7, wherein the suction cup further comprises:
a first plurality of radially oriented ribs spaced around a distal exterior surface of the proximal bellows; and
a second plurality of radially oriented ribs spaced around a proximal exterior surface of the distal bellows, the second plurality of radially oriented ribs being configured to interlock alternatingly with the first plurality of radially oriented ribs when the proximal bellows and the distal bellows at least partially collapse.

9. The end effector of claim 6, wherein the suction cup further comprises a lip connected to a distal end of the distal bellows and configured to deform to achieve a suction grip against a surface of an item being picked.

10. The end effector of claim 9, wherein the lip comprises a section of the suction cup having a wall thickness smaller than a wall thickness of the proximal bellows and the distal bellows.

11. The end effector of claim 9, wherein the lip further comprises a ridge extending circumferentially around the suction cup at a distal end of the lip, the ridge having a wall thickness greater than a wall thickness of the lip.

12. The end effector of claim 9, wherein the lip comprises an interior surface disposed at an angle between 20° and 40° relative to the longitudinal axis.

13. The end effector of claim 12, wherein the angle is approximately 30°.

14. The end effector of claim 1, wherein the suction cup comprises a silicone rubber having a Shore durometer of 30.

15. The end effector of claim 1, wherein the end effector is configured to pick an apple from a tree.

16. A method of picking a fruit from a tree, the method comprising, by a robotic process:
activating a vacuum generator of an end effector to create suction through a suction cup of the end effector, the end effector comprising:
a body;
a shaft slidably coupled to the body and extending along a longitudinal axis between a proximal end connected to the vacuum generator and a distal end coupled to the suction cup, the shaft having a vacuum lumen extending therethrough such that the vacuum generator is in fluid communication with an interior volume of the suction cup; and
a linear actuator configured to slide the shaft along the longitudinal axis relative to the body;
engaging the fruit with the suction cup; and
retracting the shaft of the end effector using the linear actuator, from an extended position to a retracted position, to pull the fruit away from the tree along the longitudinal axis of the shaft.

17. The method of claim 16, wherein retracting the shaft causes a stem of the fruit to break or to separate from the tree.

18. The method of claim 16, further comprising, subsequent to engaging the fruit with the suction cup, activating a motor of the end effector to rotate the shaft, the suction cup, and the fruit about the longitudinal axis of the shaft.

19. The method of claim 18, wherein the motor causes the fruit to rotate at a speed that causes a stem of the fruit to break or to separate from the tree.

20. The method of claim 18, wherein the motor causes the fruit to rotate through a range of motion that fatigues the stem, and wherein retracting the shaft causes a stem of the fruit to break or to separate from the tree.

21. The method of claim 18, wherein engaging the fruit with the suction cup comprises moving the end effector at least partially along a direction parallel to the longitudinal axis to approach the fruit.

22. The method of claim 21, further comprising activating the motor to cause rotation of the suction cup while approaching the fruit.

23. The method of claim 21, further comprising directing exhaust gas from the vacuum generator toward the fruit while approaching the fruit.

24. The method of claim 18, wherein the suction cup comprises a proximal bellows, a distal bellows, and a lip that engages the fruit, the proximal bellows and the distal bellows being disposed between the lip and the shaft.

25. The method of claim 24, wherein engaging the fruit with the suction cup causes the proximal bellows and the distal bellows to at least partially collapse such that a plurality of first ribs on the proximal bellows interlock with a plurality of second ribs on the distal bellows to facilitate transfer of torque from the shaft to the fruit.

26. The method of claim 16, wherein the fruit is an apple.
